(19) United States
(12) Patent Application Publication
(10) Pub. No.: US 2026/0237632 A1
(43) Pub. Date: Aug. 13, 2026

(54) THERMAL PROCESSING METHODS AND SYSTEMS FOR SOLVENT-FREE, DRY MANUFACTURING OF ELECTRODES

(71) Applicant: The Texas A&M University System, College Station, TX (US)

(72) Inventors: Heng PAN, College Station, TX (US); Kai-Jen WU, College Station, TX (US); Chinmoy PODDER, Burlington, MA (US); Jay Jie SHI, Acton, MA (US)

(21) Appl. No.: 19/227,898

(22) Filed: Jun. 4, 2025

Related U.S. Application Data
(60) Provisional application No. 63/756,663, filed on Feb. 10, 2025.

(51) Int. Cl. H01M 4/04; H01M 4/139; H01M 4/62

(52) U.S. Cl. CPC H01M 4/0471; H01M 4/0404; H01M 4/043; H01M 4/139; H01M 4/623; H01M 4/625

(57) ABSTRACT

A method for tailoring the mechanical properties of an electrode during the solvent-free, dry manufacture of the electrode includes (a) mixing a dry powder including a binder, wherein the binder in the dry powder has a first crystallinity. In addition, the method includes (b) depositing the dry powder onto a substrate after (a). Further, the method includes (c) passing the dry powder through an electrode production sub-system to form an electrode from the dry powder on the substrate after (b). The method also includes (d) passing the electrode on the substrate through an electrode processing sub-system after (c). Still further, the method includes (e) heating the electrode during (d) to a temperature greater than room temperature to at least partially melt the binder in the electrode. Moreover, the method includes (f) cooling the electrode after (e) and during (d). The binder in the electrode has a second crystallinity after (f) that is less than the first crystallinity.

### CROSS-REFERENCE TO RELATED APPLICATIONS

This application claims benefit of U.S. provisional patent application Ser. No. 63/756,663 filed Feb. 10, 2025, and entitled “Thermal Processing Methods and Apparatus for Solvent-Free Manufacturing of Electrodes,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The disclosure relates generally to methods and apparatus for dry manufacturing electrodes for energy storage devices such as batteries (e.g., lithium ion batteries, solid-state batteries, etc.). More specifically, the disclosure relates to methods and apparatus for controlling the crystallinity and crystalline structures of binder materials in the dry powder used to form the solvent-free, dry-manufactured electrodes by thermal and/or mechanical processing to optimize the mechanical properties of the electrodes.

### BACKGROUND

Dry electrode manufacturing offers a sustainable alternative to traditional solvent-based methods, particularly for using polyvinylidene fluoride (PVDF) as a binder in battery production. Unlike solvent methods, which require hazardous solvents like N-Methyl-2-pyrrolidone (NMP) and energy-intensive drying processes, dry manufacturing methods eliminate solvents entirely, thereby reducing environmental impacts, production costs, and energy consumption. The dry manufacturing methods not only simplify manufacturing but also align with industry goals for greener, more efficient production processes while maintaining or even exceeding the mechanical and electrochemical performance of electrodes made by traditional wet manufacturing methods.

### BRIEF SUMMARY OF THE DISCLOSURE

Embodiments of methods for tailoring one or more mechanical properties of an electrode during the solvent-free, dry manufacture of the electrode are disclosed herein. In one embodiment, a method for tailoring one or more mechanical properties of an electrode during the solvent-free, dry manufacture of the electrode comprises (a) mixing a dry powder including a binder, wherein the binder in the dry powder has a first crystallinity. In addition, the method comprises (b) depositing the dry powder onto a substrate after (a). Further, the method comprises (c) passing the dry powder through an electrode production sub-system to form an electrode from the dry powder on the substrate after (b). The method also comprises (d) passing the electrode on the substrate through an electrode processing sub-system after (c). Still further, the method comprises (e) heating the electrode during (d) to a temperature greater than room temperature to at least partially melt the binder in the electrode. Moreover, the method comprises (f) cooling the electrode after (e) and during (d). The binder in the electrode has a second crystallinity after (f) that is less than the first crystallinity.

Embodiments of systems for a solvent-free, dry manufacturing of an electrode are disclosed herein. In one embodiment, a system for a solvent-free, dry manufacturing of an electrode comprises a substrate configured to move in a feed direction. In addition, the system comprises a powder delivery system configured to deposit a dry powder onto a surface of the substrate. The dry powder comprises a binder. Further, the system comprises an electrode production sub-system configured to form an electrode on the substrate from the dry powder. The system also comprises an electrode processing sub-system configured to thermally process the electrode. The electrode processing sub-system comprises a heating device configured to increase a temperature of the electrode and a cooling device positioned downstream of the heating device relative to the feed direction. The cooling device is configured to decrease the temperature of the electrode.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic side view an embodiment of a system for dry-manufacturing electrodes for energy storage devices in accordance with principles described herein;

FIG. 2A is a schematic view of an exemplary micro-particle and a plurality of exemplary nano-particles that can be used to form the dry powder of FIG. 1;

FIG. 2B is a schematic view of an exemplary nano-particle coated micro-particle formed from the exemplary micro-particle and exemplary nano-particles of FIG. 2A;

FIG. 2C is a schematic view of an exemplary pair of nano-particle coated micro-particles formed from the exemplary micro-particle and exemplary nano-particles of FIG. 2A;

FIG. 3 is a schematic side view an embodiment of a system for dry-manufacturing electrodes for energy storage devices in accordance with principles described herein;

FIG. 4 is a schematic side view an embodiment of a system for dry-manufacturing electrodes for energy storage devices in accordance with principles described herein;

FIG. 5 is a flowchart illustrating an embodiment of a method for manufacturing a processed electrode in accordance with the principles described herein;

FIGS. 6A and 6B are graphical illustrations of the temperature profiles used to thermally process PVDF pellets and PVDF/CB composite pellets as described in Example 1;

FIGS. 7A and 7B are graphical illustrations of the temperature and pressure profiles employed to cold press and thermally process NMC/PVDF/CB composite pellets as described in Example 1, PVDF pellets and PVDF/CB composite pellets as described in Example 2, and PVDF pellets and PVDF/CB composite pellets as described in Example 3;

FIGS. 7C and 7D are graphical illustrations of the temperature and pressure profiles employed to cold press and thermally process PVDF pellets and PVDF/CB composite pellets as described in Example 2;

FIGS. 7E to 7H are graphical illustrations of the temperature and pressure profiles employed to hot press and thermally process PVDF pellets and PVDF/CB composite pellets as described in Example 2;

FIGS. 8A to 8C are scanning electron microscope (SEM) images of the microstructure of a cold pressed PVDF pellet subjected to a 200 MPa compression pressure without any heat treatment at resolutions of 20 μm, 2 μm, and 500 nm, respectively, as described in Example 2;

FIGS. 8D to 8F are SEM images of the microstructure of a cold pressed PVDF pellet subjected to a 200 MPa compression pressure followed by a heat treatment at 200° C. for 1 hour at resolutions of 20 μm, 1 μm, and 500 nm, respectively, as described in Example 2;

FIGS. 9A and 9B are stress-strain curves resulting from the uniaxial tensile tests of PVDF pellets as described in Example 3;

FIGS. 9C and 9D are stress-strain curves resulting from the uniaxial tensile tests of PVDF/CB composite pellets as described in Example 3; and

FIGS. 9E and 9F are stress-strain curves resulting from the uniaxial tensile tests of NMC/PVDF/CB composite pellets as described in Example 3.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim.

The term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As previously described, solvent-free, dry electrode manufacturing methods offer several advantages over conventional wet electrode manufacturing methods. A key factor in the solvent-free, dry fabrication of high-performance electrodes is the composition of the dry powder used to form the electrodes, and in particular, the binder in the dry powder, which plays a key role in maintaining the structural integrity of the electrode formed with the dry powder. Thermoplastic polymers such as polytetrafluoroethylene (PTFE), polyvinylidene fluoride (PVDF), and poly(vinyl alcohol) (PVA) have become prominent binders due to their chemical stability. However, optimizing the mechanical properties of such binders (and compositions including such binders) has presented unique challenges, especially in the context of solvent free, dry manufacturing. It has been discovered that the morphology, crystallinity, and crystalline structure of the binders impacts the mechanical properties of the resulting electrodes, and further, that thermal processing involving heating and quenching, mechanical processing involving pressure, and combinations thereof can be used to tailor the morphology, crystallinity, and crystallinity structures of the binders.

Thermal processing and mechanical processing of the dry powder including binders (e.g., PVDF) for the solvent-free, dry manufacturing of electrodes disclosed herein involves subjecting the dry powder containing binders, active materials, and conductive materials on a moving substrate to temperature and/or pressure changes with controlled temperature and pressure profiles. The thermal processing apparatus may include a heating device (including heating rolls, laser beams, flash lamp, pulsed light source, hot plates, etc.) and a cooling device (including chill rolls, cold substrates, etc.) integrated on a roll-to-roll platform.

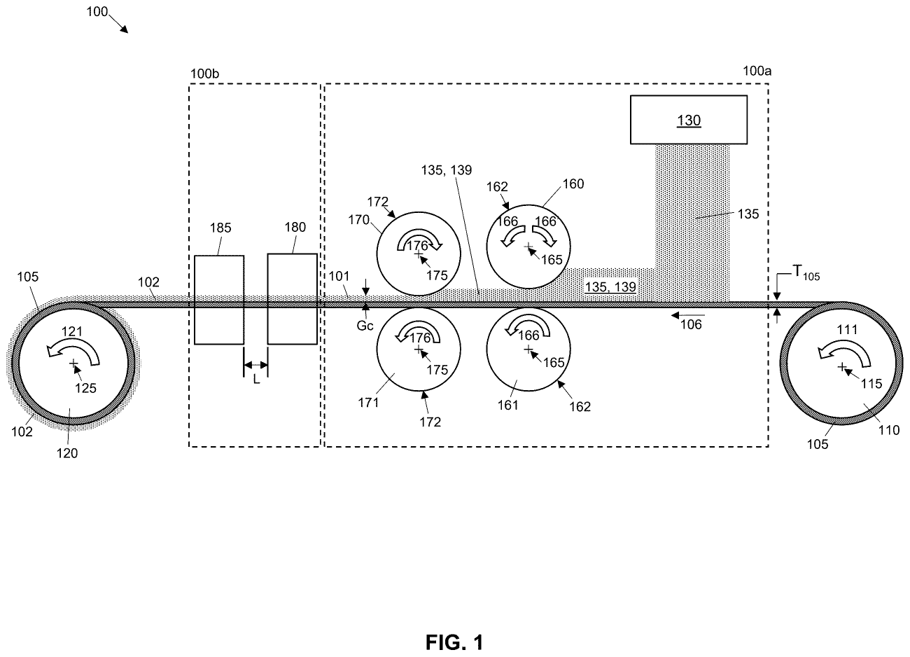

Referring now to FIG. 1, an embodiment of a system 100 for dry manufacturing electrodes for energy storage devices such as batteries (e.g., Li-ion batteries, solid-state batteries, etc.) is shown. In this embodiment, system 100 mechanically produces a continuous sheet or layer of electrode material 101 on a web or substrate 105 from a solvent-free, dry powder 135, and then processes the produced layer of electrode material 101 to form a processed electrode material 102 with enhanced mechanical properties as compared to electrode material 101. Accordingly, system 100 may be described as including two stages—an electrode production sub-system 100a that produces the layer of electrode material 101 on substrate 105 from dry powder 135, and an electrode processing sub-system 100b that processes the produced layer of electrode material 101 to form processed electrode material 102. Thus, processing of electrode material 101 via electrode processing sub-system 100b improves the mechanical properties of electrode material 101 manufactured by production sub-system 100a. The processed electrode material 102 and substrate 105 can be cut as desired to produce a plurality of individual electrodes for use in energy storage devices. For purposes of clarity and further explanation, electrode material 101 may simply be referred to herein as electrode 101 or unprocessed electrode 101, and electrode material 102 may simply be referred to herein as electrode 102 or processed electrode 102. It is to be understood that powder 135 is “dry,” meaning it does not include any solvent.

System 100 includes an unwinding or supply roller 110 and a winding or receiving roller 120 horizontally spaced from the supply roller 110. Supply roller 110 generally provides a continuous sheet of substrate 105 on which electrode 101, 102 is formed with sub-systems 100a, 100b, respectively. In general, substrate 105 can be unwound from supply roller 110, or provided by another roller (not shown) and passed over supply roller 110 to the remainder of system 100. Supply roller 110 rotates in a rotational direction 111 about a central axis 115 to supply substrate 105 in a generally horizontal feed direction 106 through system 100. In other words, supply roller 110 supplies substrate 105 in the feed direction 106 through both sub-systems 100a, 100b. As shown in the side view of FIG. 1, rotational direction 111 is counterclockwise and feed direction 106 is to the left. In embodiments described herein, substrate 105 is fed from supply roller 110 and moved in feed direction 106 at a feed rate or speed greater than 0.0 m/min and less than or equal to 120.0 m/min. For purposes of clarity and further explanation, the terms “upstream” and “downstream” are used herein to refer to positions of different components of system 100 relative to feed direction 106.

Receiving roller 120 is downstream of supply roller 110 and generally receives the continuous sheet of substrate 105 and electrode 102 formed thereon. Substrate 105 and electrode 102 can be wound onto receiving roller 120, or passed over receiving roller 120 to another roller (not shown). Receiving roller 120 rotates in a rotational direction 121 about a central axis 125 to receive substrate 105 and electrode 102 along the generally horizontal feed direction 106. As shown in FIG. 1, rotational direction 121 is counterclockwise, and thus, rotational directions 111, 121 of supply roller 110 and receiving roller 120, respectively, are the same. As previously described, in embodiments described herein, substrate 105 is moved in feed direction 106 at a feed rate or speed ranging greater than 0.0 m/min and less than or equal to 120.0 m/min, and thus, substrate 105 and electrode 102 formed thereon are received by receiving roller 120 at that same rate.

Referring still to FIG. 1, electrode production sub-system 100a of system 100 includes a powder supply or deposition system 130, a first pair of vertically arranged rollers 160, 161, and a second pair of vertically arranged rollers 170, 171 horizontally spaced from and downstream of first pair of rollers 160, 161. Powder deposition system 130, first pair of rollers 160, 161, and second pair of rollers 170, 171 are positioned between supply roller 110 and electrode processing sub-system 100b. These components of electrode production sub-system 100a are generally horizontally arranged side-by-side. More specifically, powder deposition system 130 is horizontally positioned between supply roller 110 and first pair of rollers 160, 161, first pair of rollers 160, 161 are horizontally positioned between second pair of rollers 170, 171 and powder deposition system 130, and second pair of rollers 170, 171 are horizontally positioned between first pair of rollers 160, 161 and electrode processing sub-system 100b. Thus, powder deposition system 130 is downstream of supply roller 110, first pair of rollers 160, 161 are downstream of powder deposition system 130, second pair of rollers 170, 171 are downstream of first pair of rollers 160, 161, and electrode processing sub-system 100b is downstream of second pair of rollers 170, 171.

Substrate 105 is a sheet of conductive material onto which electrode 101, 102 is formed (e.g., the upper surface of substrate 105 as shown in FIG. 1). In general, substrate 105 can be a sheet of any suitable conductive material including, without limitation, a sheet of aluminum foil or a sheet of copper foil. Substrate 105 has a thickness T₁₀₅ measured perpendicularly between its upper and lower surfaces. In embodiments, described herein, the thickness T₁₀₅ of substrate 105 ranges from 1.0 micron to 200.0 micron, and alternatively ranges from 1.0 micron to 30.0 micron. In addition, substrate 105 has a uniform width measured perpendicular to feed direction 106 between the parallel, lateral sides or edges of substrate 105.

Powder deposition system 130 generally feeds or delivers a dry powder 135 that is used to form electrode 101 on substrate 105. In particular, powder deposition system 130 deposits a continuous layer 139 of dry powder 135 onto the upper surface of substrate 105, which carries and moves layer 139 of dry powder 135 in feed direction 106 through electrode production sub-system 100a and then electrode processing sub-system 100b. For most electrode manufacturing operations, the mass feed rate of dry powder 135 onto substrate 105 by powder deposition system 130 is greater than 0.0 gram/s and less than or equal to 300.0 gram/s per 100 mm of width W₁₀₅ of substrate 105. As shown in FIG. 1 and described in more detail below, first pair of rollers 160, 161 and second pair of rollers 170, 171 spread and/or compact the deposited layer 139 of dry powder 135 on substrate 105 to form electrode 101 on substrate 105.

In embodiments in which electrode 101, 102 is manufactured for use in Li-ion batteries, dry powder 135 includes an active material, a binder, and a conductive additive (each in a powder form). Optionally, one or more solid-state electrolytes (also in a powder form) can be included in dry powder 135 when electrode 101 is manufactured for use in solid-state Li-ion batteries. Regardless of whether electrode 101, 102 is manufactured for use in a Li-ion battery or an all-solid-state battery, dry powder 135 comprises at least 70 wt % active material and less than 30 wt % other components. The active material can include, without limitation, cathode materials such as lithium transition metal oxides, lithium transition metal sulfides, lithium transition metal phosphates (e.g., lithium nickel-cobalt-manganese oxide (NMC), lithium iron phosphate (LFP), lithium cobalt oxide (LCO)), sodium manganese oxide, sodium cobalt phosphate, sodium nickel phosphate, sodium iron phosphate, sodium manganese phosphate, sodium iron hexacyanoferrate, sodium manganese hexacyanoferrate, or combinations thereof; and anode materials such as graphite, carbonaceous anode materials (e.g., graphite, graphene, disordered carbon, and the like), lithium transition metal oxides, Si-based composites, or combinations thereof. The binder can include, without limitation, a thermoplastic polymer such as polytetrafluoroethylene (PTFE), polyvinylidene fluoride (PVDF), poly(vinyl alcohol) (PVA), polyethylene oxide (PEO), poly(methyl methacrylate) (PMMA), styrene-butadiene rubber (SBR), polyurethanes, ethylene vinyl acetate (EVA), acrylic polymers, polyethylene (PE), other thermoplastic polymer, or combinations thereof. The conductive additive can include, without limitation, one or more of carbon black (CB), nanoparticles, nanowires, nanotubes (e.g., carbon nanotubes (CNT)), carbon fibers, graphene, nanosilica, nanoalumina, or the like. The one or more solid-state electrolytes can include, without limitation, solid polymer electrolyte PEO/LiTFSI, lithium lanthanum zirconium oxide (LLZO), lithium lanthanum titanate (LLTO), Li₃InCl₆, Li₆PS₅Cl, silica nanofillers, Al₂O₃ nanofillers, LLZO nanofillers, or combinations thereof. In some embodiments, the solid-state electrolyte can function as a binder, in which case the binder may be described as comprising a solid-state electrolyte. In some embodiments, the solid-state electrolyte can function as an active material, in which case the active material may be described as comprising a solid-state electrolyte.

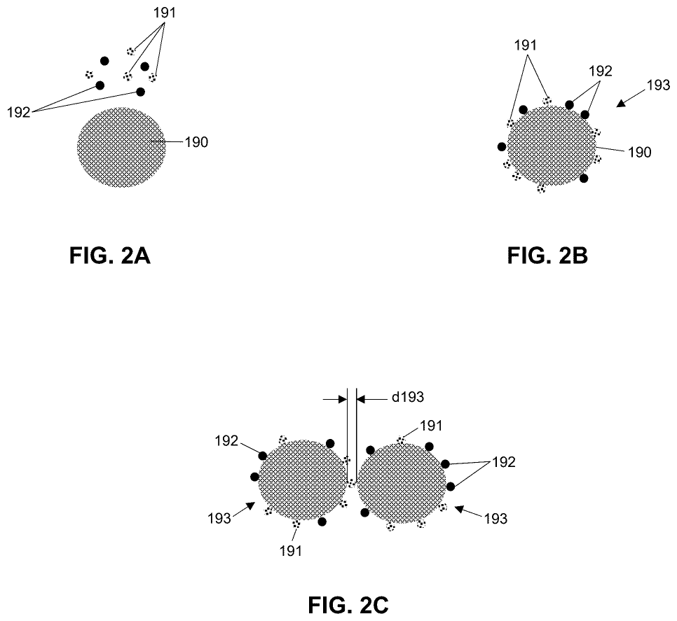

In some embodiments, dry powder 135 comprises a plurality of micro-particles at least partially coated in a plurality of nano-particles (i.e., each micro-particle is at least partially coated in a plurality of nano-particles). As used herein, the term “micro-particle” refers to a single, individual particle, which may comprise, without limitation, a single crystal particle, a polycrystal particle, a partial crystalline particle, a composite particle, or an aggregate or agglomeration of a plurality of smaller particles (e.g., a plurality of smaller single crystal particles, a plurality of polycrystal particles, a particle of an amorphous material, a plurality of nano-particles, or combinations thereof), having a size (e.g., diameter or average diameter) greater than or equal to 1.0 micron; and the term “nano-particle” refers to a single, individual particle, which may comprise, without limitation, a single crystal particle, a polycrystal particle, a particle of an amorphous material, or a partial crystalline particle having a size (e.g., diameter or average diameter) less than 1.0 micron. Thus, in embodiments where dry powder 135 comprises a plurality of micro-particles at least partially coated in a plurality of nano-particles, the micro-particles in dry powder 135 have sizes that are preferably at least 10× the size of the nano-particles. For example, referring briefly to FIG. 2A, a single micro-particle 190 comprising a first material (e.g., an active material), a first plurality of nano-particles 191 comprising a second material (e.g., conductive additive), and a second plurality of nano-particles 192 comprising a third material (e.g., binder) are shown. The micro-particle 190 has a size that is at least 10× the size of the first plurality of nano-particles 191 and the second plurality of nano-particles 192. In FIG. 2B, the micro-particle 190 is shown coated in the nano-particles 191 and the nano-particles 192 to form one nano-particle coated micro-particle 193. A plurality of such nano-particle coated micro-particles 193 can be used as dry powder 135.

In general, the sizes of the various components in dry powder 135 (e.g., active material, binder, conductive additive, solid-state electrolytes, etc.) can range from nanometers (e.g., nano-particles) to tens of microns (e.g., micro-particles). For example, the active materials may have sizes ranging from 0.5 micron to 40 microns, whereas the conductive additives and some of the solid polymer electrolyte (e.g., nanofillers) can have sizes less than 1 micron. In general, any one or more of the individual components in dry powder 135 (e.g., active material, binder, conductive additive, solid-state electrolytes, etc.) can serve as and define the micro-particles, and any one or more of the individual components in dry powder 135 (e.g., active material, binder, conductive additive, solid-state electrolytes, etc.) can serve as and define the nano-particles. For example, in FIGS. 2A and 2B, the micro-particle 190 may comprise an active material, the first plurality of nano-particles 191 may comprise conductive additives, and the second plurality of nano-particles 192 may comprise binder.

In some embodiments, each micro-particle (e.g., each micro-particle 190) preferably has a size ranging from 1.0 micron to 30.0 microns and each nano-particle preferably has a size ranging from 1.0 nm to 500.0 nm. In general, the nano-particle coated micro-particles forming dry powder 135 can be prepared by any suitable means known in the art (e.g., intensive dry mixing) and then added to powder deposition system 130 for controlled deposition on substrate 105.

In addition to the active material, the binder, the conductive additive, and other optional components described above (e.g., solid-state electrolytes for solid-state Li-ion batteries), the dry powder 135 can optionally include other types of nano-particles as functional additives to fine-tune particular aspects of battery performance such as safety, energy density, integrity, rate performance, and cycle life. For instance, TiO₂ nano-particles can be added in graphite (micro-particle) anode to improve rate capability and thermal stability. Further, particles or units of nanomaterials such as nanowires and/or nanotubes can be used in conjunction with nano-particles or as an alternative to nano-particles to coat the micro-particles to achieve similar effects. Examples of such other nanomaterials include hollow nano-particles, core-shell nano-particles, nano-dots, nano-tubes, nano-rods, nano-wires, nano-sheets. (graphene quantum dots, silicon nano-wires, carbon nano-tubes, silicon nano-tubes, nano-sized carbon fiber, mesoporous carbon, graphene, etc.). Any such particles or units of nanomaterials preferably have at least one dimension less than 1.0 micron, and more preferably at least one dimension less than 100 nm.

As previously described, in some embodiments, dry powder 135 comprises a plurality of nano-particle coated micro-particles 193. However, in other embodiments, dry powder 135 may comprise a mixture of other types of particles other than nano-particle coated micro-particles 193.

Referring still to FIG. 1, in this embodiment, first pair of rollers 160 161 uniformly spread and/or compact layer 139 of dry powder 135 deposited on the upper surface of substrate 105, and then second pair of rollers 170, 171 compact (or further compact) layer 139 of dry powder 135 deposited on the upper surface of substrate 105 to form electrode 101. For example, first pair of rollers 160, 161 may spread layer 139 of dry powder 135 on substrate 105, and then second pair of rollers 170, 171 may compact the spread layer 139 of dry powder 135 on substrate 105; or first pair of rollers 160, 161 may compact layer 139 of dry powder 135 on substrate 105, and then second pair of rollers 170, 171 may further compact layer 139 of dry powder 135 on substrate 105. Thus, in embodiments described herein, first pair of rollers 160, 161 may function to spread or compact layer 139 of dry powder 135, wherein second pair of rollers 170, 171 function to compact layer 139 of dry powder 135. Accordingly, second pair of rollers 170, 171 may also be referred to herein as compaction rollers 170, 171.

In this embodiment, first pair of rollers 160, 161 are vertically arranged one-above-the-other, and thus, may be described as an upper roller 160 and a lower roller 161. Each roller 160, 161 has a central axis 165 about which it may rotate, and a radially outer cylindrical surface 162. In this embodiment, first pair of rollers 160, 161 are positioned such that central axes 165 are disposed in a common vertical plane. Consequently, the uppermost portion of outer surface 162 of lower roller 161 is directly, vertically opposed to the lowermost portion of outer surface 162 of upper roller 160. The lower portion of upper roller 160 directly contacts and spreads dry powder 135 on substrate 105, while the upper portion of lower roller 161 directly contacts and supports the lower surface of substrate 105. In general, upper roller 160 can rotate in a direction 166 about axis 165 (counterclockwise in FIG. 1), rotate in a direction 166′ about axis 165 that is opposite direction 166 (clockwise in FIG. 1), or not rotate about axis 165. Lower roller 161 rotates in direction 166 about its axis 165 (counterclockwise in FIG. 1).

In this embodiment, second pair of rollers 170, 171 are vertically arranged one-above-the-other, and thus, may be described as an upper roller 170 and a lower roller 171. Each roller 170, 171 has a central axis 175 about which it rotates in a rotational direction 176, and a radially outer cylindrical surface 172. In this embodiment, second pair of rollers 170, 171 are positioned such that central axes 175 are disposed in a common vertical plane. However, in other embodiments, the central axes of the compaction rollers (e.g., central axes 175 of compaction rollers 170, 171) may not lie in a common vertical plane. Consequently, the uppermost portion of outer surface 172 of lower roller 171 is directly, vertically opposed the lowermost portion of outer surface 172 of upper roller 170. The lower portion of upper roller 170 directly contacts and compacts dry powder 135 on substrate 105 to form unprocessed electrode 101 on substrate 105, while the upper portion of lower roller 171 directly contacts and supports the lower surface of substrate 105. In embodiments described herein, compaction rollers 170, 171 can apply a compaction load of up to about 3.5 tons/cm to compress dry powder 135 (along a line contact between roller 170 and dry powder 135), and more preferably apply a compaction load ranging from 0.01 to 1.5 tons/cm to compress dry powder 135 (along a line contact between roller 170 and dry powder 135).

Rotational directions 176 of compaction rollers 170, 171 are opposite to each other. For example, in FIG. 1, rotational direction 176 of upper compaction roller 170 is clockwise, whereas rotational direction 176 of lower compaction roller 171 is counter-clockwise. However, due to the positioning of compaction rollers 170, 171 above and below, respectively, substrate 105 and dry powder 135, rotational directions 176 are generally in the same direction as feed direction 106 proximal substrate 105 and dry powder 135. In particular, due to the rotational direction 176 of upper compaction roller 170, the lower portion of outer surface 172 of upper compaction roller 170 contacting dry powder 135 moves in the same direction as feed direction 106; and due to the rotational direction 176 of lower compaction roller 171, the upper portion of outer surface 172 of lower compaction roller 171 contacting substrate 105 moves in the same direction as feed direction 106.

Compaction rollers 170, 171 are vertically-spaced apart a sufficient distance to provide a gap Gc measured vertically from the upper surface of substrate 105 to the lowermost portion of outer surface 172 of upper compaction roller 170. Thus, the vertical distance between compaction rollers 170, 171 is equal to the thickness T₁₀₅ plus gap Gc. It should be appreciated that gap Gc defines the vertical thickness to which dry powder 135 is compacted on substrate 105 by compaction rollers 170, 171 to form electrode 101. Thus, gap Gc defines the thickness of electrode 101. In embodiments described herein, gap Gc, and hence the vertical thickness of dry powder 135 after passing between compaction rollers 170, 171 and the thickness of electrode 101, ranges from 0.0 to 3,000.0 micron, and alternatively ranges from 0.0 micron to 500.0 micron.

Referring still to FIG. 1, electrode processing sub-system 100b is downstream of electrode production sub-system 100a and includes a heating device 180 and a cooling device 185 for thermally processing electrode 101 produced by sub-system 100a, thereby converting unprocessed electrode 101 to processed electrode 102 as it passes from electrode production sub-system 100a through electrode processing sub-system 100b to receiving roller 120. In this embodiment, electrode processing sub-system 100b only includes heating device 180 and cooling device 185, which heat and then cool electrode 101, and does not include any mechanical processing components or equipment (e.g., a compaction roller). Accordingly, in this embodiment, electrode processing sub-system 100b may also be referred to as an electrode thermal processing sub-system 100b. As will be described in more detail below, in other embodiments, additional components or devices may be provided in electrode processing sub-system 100b to mechanically process electrode 101 (e.g., to compress electrode 101).

As shown in FIG. 1, cooling device 185 is positioned downstream of heating device 180, and in particular, is spaced a distance L downstream of heating device 180. In embodiments disclosed herein, the distance L is defined as the minimum length of substrate 105 measured from the final or most downstream point at which electrode 101 is heated with heating device 180 to the initial or most upstream point at which electrode 101 is cooled with cooling device 185. The distance L is preferably set such that the distance L divided by the speed of substrate 105 in feed direction 106 is less than 10.0 s, alternatively less than 1.0 s, alternatively less than 0.10 s, alternatively less than 0.01 s, and alternatively less than 0.001 s.

In general, heating device 180 can be any suitable device known in the art for heating and increasing the temperature of electrode 101 including, without limitation, a conductive heating device that transfers thermal energy to electrode 101 via conduction (e.g., a hot roller, a hot plate, etc.), a radiative heating device that transfer thermal energy to electrode 101 via radiation (e.g., a flash lamp, a laser, a directional radiation, a CO2 laser (e.g., ~10.6 μm wavelength), a diode laser, a fiber laser, a pulsed light source (e.g., with a pulse duration less than 20 ms), etc.), or an inductive heating device that transfers thermal energy to electrode 101 via electromagnetic induction (e.g., inductive coil, etc.); and cooling device 185 can be any suitable device known in the art for cooling and reducing the temperature of electrode 101 including, without limitation, a heatsink, a chilled roller, a cold substrate or plate, a cooled gas stream, etc.

As the names imply, heating device 180 transfers thermal energy to electrode 101 to increase the temperature of electrode 101, and cooling device 185 subsequently cools electrode 101 to decrease the temperature of electrode 101. It is to be understood that heating electrode 101 in electrode processing sub-system 100b inherently results in heating of dry powder 135 (including the binder) therein, and the cooling of electrode 101 in electrode processing sub-system 100b inherently results in cooling of dry powder 135 (including the binder) therein. As will be described in more detail below, such thermal processing can be used to at least partially melt and then re-solidify the binder in electrode 101, and adjust the crystallinity of the binder (e.g., reduce the crystallinity of the binder) in electrode 101 to enhance mechanical properties of processed electrode 102 as compared to unprocessed electrode 101. For example, such thermal processing offers the potential to improve the structural integrity of processed electrode 102 as compared to unprocessed electrode 101, as well as enhance bonding of the binder with other constituents of dry powder 135 and with substrate 105 in processed electrode 102 as compared to unprocessed electrode 101, and improve the ability of processed electrode 102 to withstand deformation as compared to unprocessed electrode 101. In embodiments described herein, it is generally preferred to reduce the crystallinity of the binder in unprocessed electrode 101 to enhance the mechanical properties of processed electrode 102 as compared to unprocessed electrode 101. In this embodiment, to achieve such reduction in the crystallinity of the binder in dry powder 135, heating of electrode 101 by heating device 180 and subsequent cooling of electrode 101 by cooling device 185 is performed in a predetermined manner by controlling one or more of (i) the rate (e.g., ° C./min) at which the temperature of electrode 101 is increased from the ambient room temperature by heating device 180, (ii) the elevated temperature (e.g., ° C.) to which electrode 101 is heated to by heating device 180, (iii) the time (e.g., milliseconds, seconds, or minutes) over which electrode 101 is maintained at or near the elevated temperature during or following heating by heating device 180, and (iv) the rate (e.g., C/min) at which the temperature of electrode 101 is decreased from the elevated temperature back to the ambient room temperature by cooling device 185. For purposes of clarity and further explanation, heating rates resulting in increasing of the temperature of electrode 101 may be expressed as positive rates (e.g., +10° C./min), and cooling rates resulting in decreasing of the temperature of electrode 101 may be expressed as negative rates (e.g., −10° C./min). In embodiments described herein, the heating rate of electrode 101 by heating device 180 preferably ranges from +30° C./min to +1.2×10⁷° C./min, alternatively ranges from +40° C./min to +1.2×10⁴° C./min, alternatively ranges from +50° C./min to +4000° C./min, and alternatively ranges from +100° C./min to +600° C./min; the elevated temperature to which electrode 101 is heated from ambient room temperature the elevated temperature by heating device 180 is preferably greater than or equal to the melting point of the binder in electrode 101, and alternatively is equal to or greater than 200° C.; the time over which dry electrode 101 is maintained at the elevated temperature following heating by heating device 180 is preferably less than 1.0 s, alternatively less than 0.10 s, alternatively less than 0.01 s, and alternatively less than 0.001 s; and the rate at which the temperature of dry powder is decreased from the elevated temperature back to the ambient room temperature by cooling device 185 is preferably faster than or equal to −100° C./min, alternatively faster than or equal to −200° C./min, alternatively faster than or equal to −600° C./min, alternatively faster than or equal to −1.2×10⁴° C./min, and alternatively faster than or equal to −1.2×10⁷° C./min. As previously described, cooling rates are expressed as negative rates, and thus, a cooling rate of −600° C./min is a faster cooling rate (i.e., a faster temperature decrease) than a cooling rate of −200° C./min, which is a faster cooling rate (i.e., a faster temperature decrease) than −100° C./min. As the cooling of dry powder with cooling device 185 is relatively rapid, and is intended to alter and control the crystallinity and mechanical properties of unprocessed electrode 101, the cooling of unprocessed electrode 101 may also be referred to as quenching.

Controlling one or more of the foregoing parameters during processing of electrode 101 with electrode processing sub-system 100b of system 100 offers the potential to advantageously decrease the crystallinity of the binder (e.g., thermoplastic binders) by about 1% to 40%, and alternatively by at least 20%. It is to be understood that a change in crystallinity of a binder in the dry powder 135 forming an electrode (e.g., electrode 101) during processing (e.g., by electrode processing sub-system 100b) is calculated as follows:

$$\% Change in Crystallinity = \frac{( \% {Crystallinty}_{p} - \% {Crystallinty}_{u} )}{\% {Crystallinty}_{u}} \times 100 \%$$

where, % Crystallintyₚ is the % Crystallinity of the binder in the dry powder after processing (e.g., after passing through electrode processing sub-system 100b), and % Crystallinityᵤ is the % Crystallinity of the binder in the dry powder before processing (e.g., before passing through electrode processing sub-system 100b).
   Thus, the crystallinity of the binder in processed electrode 102 may be about 1% to 40% less than the crystallinity of the binder in unprocessed electrode 101, and alternatively, the crystallinity of the binder in processed electrode 102 may be at least 20% less than the crystallinity of the binder in unprocessed electrode 101. In general, the crystallinity of the binder can be investigated, measured, and determined via techniques known in the art such as Differential Scanning calorimeter (DSC) (e.g., DSC Q20 available from TA Instruments of New Castle, Delaware, USA) and Fourier Transform Infrared Spectroscopy (FTIR).

In the manner described, electrode production sub-system 100a of system 100 forms electrode 101 from dry powder 135 on substrate 105. Once formed, electrode 101 continues along feed direction 106 with substrate 105 to electrode processing sub-system 100b of system 100 where electrode 101 is further processed to enhance its mechanical properties.

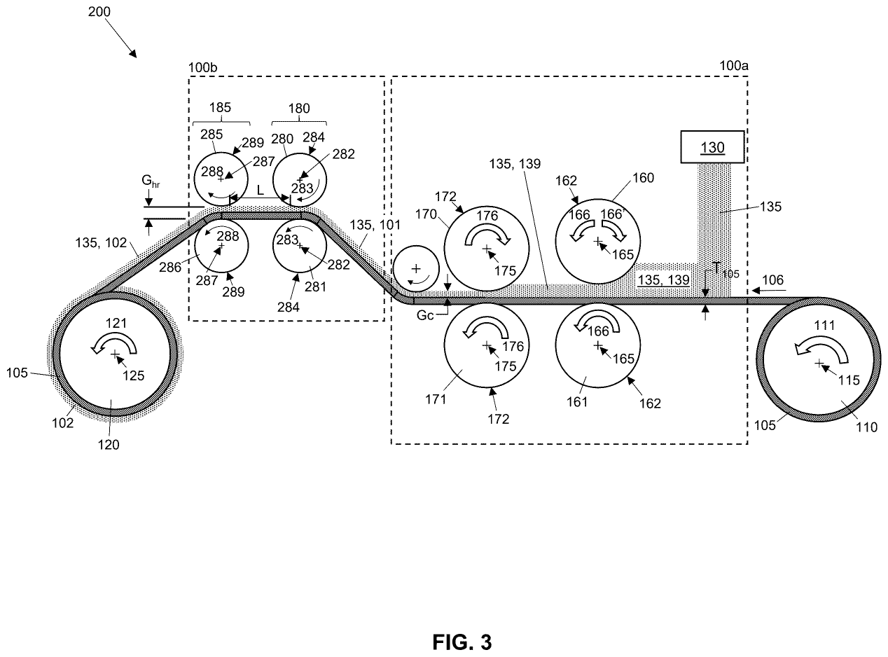

Referring now to FIG. 3, an embodiment of a system 200 for dry manufacturing electrodes for energy storage devices such as batteries (e.g., Li-ion batteries, solid-state batteries, etc.) is shown. System 200 is similar to system 100 previously described. In particular, system 200 includes an electrode production sub-system 100a that mechanically produces a continuous sheet or layer of electrode 101 on a web or substrate 105 from a solvent-free, dry powder 135; and an electrode processing sub-system 100b positioned downstream of sub-system 100a and that processes the produced layer of electrode material 101 to form a processed electrode material 102 with enhanced mechanical properties as compared to electrode material 101. Electrode production sub-system 100a is as previously described. Electrode processing sub-system 100b is similar to electrode processing sub-system 100b previously described in that it includes a heating device 180 and a cooling device 185 spaced downstream of heating device 180 by a distance L measured as previously described. However, in this embodiment, heating device 180 comprises a pair of heated or hot rollers 280, 281 and cooling device 185 comprises a pair of chilled or cold rollers 285, 286.

Referring still to FIG. 3, in this embodiment, hot rollers 280, 281 are vertically arranged one-above-the-other, and thus, may be described as an upper hot roller 280 and a lower hot roller 281. Each hot roller 280, 281 has a central axis 282 about which it rotates in a rotational direction 283, and a radially outer cylindrical surface 284. In this embodiment, hot rollers 280, 281 are positioned such that central axes 282 are disposed in a common vertical plane. Thus, the uppermost portion of outer surface 284 of lower hot roller 281 is directly, vertically opposed the lowermost portion of outer surface 284 of upper hot roller 280. The lower portion of upper hot roller 280 directly contacts electrode 101 on substrate 105, while the upper portion of lower hot roller 281 directly contacts and supports the lower surface of substrate 105.

As shown in FIG. 3, substrate 105 (and electrode 101 disposed thereon) slopes upwardly moving from electrode production sub-system 100a to lower hot roller 281, generally bends around outer surface 284 of lower hot roller 281, and extends substantially horizontally between hot rollers 280, 281 and cold rollers 285, 286. It should be appreciated that by bending substrate 105 (and electrode 101 disposed thereon) around lower hot roller 281, the contact surface area between substrate 105 and outer surface 284 of lower hot roller 281 can be increased, thereby increasing the time and contact surface area over which thermal energy can be transferred from lower hot roller 281 to substrate 105 (and hence electrode 101 disposed thereon). In this embodiment, the circumferential contact length between outer surface 284 of lower hot roller 281 and substrate 105 preferably ranges from 10.0 mm to 1000.00 mm.

In this embodiment, rotational directions 283 of hot rollers 280, 281 are opposite to each other. For example, as shown in FIG. 3, rotational direction 283 of upper hot roller 280 is clockwise, whereas rotational direction 283 of lower hot roller 281 is counter-clockwise. However, due to the positioning of hot rollers 280, 281 above and below, respectively, substrate 105 and electrode 101, rotational directions 283 of both hot rollers 280, 281 are generally in the same direction as feed direction 106 proximal substrate 105 and electrode 101. In particular, due to the rotational direction 283 of upper hot roller 280, the lower portion of outer surface 284 of upper hot roller 280 contacting electrode 101 moves in the same direction as feed direction 106; and due to the rotational direction 283 of lower hot roller 281, the upper portion of outer surface 284 of lower hot roller 281 contacting substrate 105 moves in the same direction as feed direction 106.

In this embodiment, both hot rollers 280, 281 are heated to an elevated temperature (relative to ambient room temperature) to transfer thermal energy to electrode 101 to increase the temperature of electrode 101 at a heating rate (e.g., +° C./min) to an elevated temperature (e.g., ° C.), and maintain the temperature of electrode 101 at the elevated temperature for a predetermined period of time as will be described in more detail below. In addition, in this embodiment, hot rollers 280, 281 also apply compression to electrode 101, and further compact electrode 101. More specifically, in this embodiment, hot rollers 280, 281 are vertically-spaced apart a sufficient distance to provide a gap Gnr measured vertically from the upper surface of substrate 105 to the lowermost portion of outer surface 284 of upper hot roller 280. Thus, the vertical distance between hot rollers 280, 281 is equal to the thickness T₁₀₅ plus gap Gₕᵣ. It should be appreciated that gap Gnr defines the vertical thickness to which electrode 101 is compacted on substrate 105 by hot rollers 280, 281 to process electrode 101. In embodiments described herein, gap Gₕᵣ, ranges from 0.0 to 3,000.0 micron, and alternatively ranges from 0.0 micron to 500.0 micron. In embodiments described herein, hot rollers 280, 281 can apply a compaction load of up to about 3.5 tons/cm to compress electrode 101 (along a line contact between roller 280 and electrode 101), and more preferably apply a compaction load ranging from 0.0001 to 1.5 tons/cm to compress electrode 101 (along a line contact between upper hot roller 280 and electrode 101).

Referring still to FIG. 3, in this embodiment, cold rollers 285, 286 are vertically arranged one-above-the-other, and thus, may be described as an upper cold roller 285 and a lower cold roller 286. Each cold roller 285, 286 has a central axis 287 about which it rotates in a rotational direction 288, and a radially outer cylindrical surface 289. In this embodiment, cold rollers 285, 286 are positioned such that central axes 287 are disposed in a common vertical plane. Thus, the uppermost portion of outer surface 289 of lower cold roller 286 is directly, vertically opposed the lowermost portion of outer surface 289 of upper cold roller 285. The lower portion of upper cold roller 285 directly contacts electrode 101 on substrate 105, while the upper portion of lower cold roller 286 directly contacts and supports the lower surface of substrate 105.

As shown in FIG. 3, substrate 105 (and electrode 101 disposed thereon) slopes downwardly moving from lower cold roller 286 toward receiving roller 120, and generally bends around outer surface 289 of lower cold roller 286. It should be appreciated that by bending substrate 105 (and electrode 101 disposed thereon) around lower cold roller 286, the contact surface area between substrate 105 and outer surface 289 of lower cold roller 286 can be increased, thereby increasing the time and contact surface area over which thermal energy can be transferred from substrate 105 (and hence electrode 101 disposed thereon) to lower cold roller 286. In this embodiment, the circumferential contact length between outer surface 289 of lower cold roller 286 and substrate 105 preferably ranges from 10.0 mm to 1,000.00 mm.

In this embodiment, rotational directions 288 of cold rollers 285, 286 are opposite to each other. For example, as shown in FIG. 3, rotational direction 288 of upper cold roller 285 is clockwise, whereas rotational direction 288 of lower cold roller 286 is counter-clockwise. However, due to the positioning of cold rollers 285, 286 above and below, respectively, substrate 105 and electrode 101, rotational directions 288 of both cold rollers 285, 286 are generally in the same direction as feed direction 106 proximal substrate 105 and electrode 101. In particular, due to the rotational direction 288 of upper cold roller 285, the lower portion of outer surface 289 of upper cold roller 285 contacting electrode 101 moves in the same direction as feed direction 106; and due to the rotational direction 288 of lower cold roller 286, the upper portion of outer surface 289 of lower cold roller 286 contacting substrate 105 moves in the same direction as feed direction 106.

In this embodiment, both cold rollers 285, 286 are chilled to a reduced temperature (relative to ambient room temperature) to remove thermal energy from electrode 101 to decrease the temperature of electrode 101 at a cooling rate (e.g., −° C./min) back to ambient room temperature as will be described in more detail below. In this embodiment, cold rollers 285, 286 merely contact electrode 101 and substrate 105, respectively, to cool electrode 101 but do not apply compression to electrode 101 as cold rollers 285, 286 are vertically-spaced apart a distance equal to gap Gnr measured vertically from the upper surface of substrate 105 to the lowermost portion of outer surface 289 of upper cold roller 285. Thus, gap Gnr defines the thickness of processed electrode 102 exiting electrode processing sub-system 100b. However, in other embodiments, the cold rollers (e.g., cold rollers 285, 286) may be spaced to apply compression to the electrode (e.g., electrode 101).

As previously described, in embodiments described herein, it is generally preferred to at least partially melt and re-solidify the binder, and reduce the crystallinity of the binder in electrode 101 to enhance the mechanical properties of processed electrode 102 as compared to unprocessed electrode 101. In this embodiment, to achieve such reduction in the crystallinity of the binder in electrode 101, heating of electrode 101 by hot rollers 280, 281 and subsequent cooling of electrode 101 by cold rollers 285, 286 is performed in a similar manner as previously described by controlling one or more of (i) the rate (e.g., +° C./min) at which the temperature of electrode 101 is increased from the ambient room temperature by hot rollers 280, 281, (ii) the elevated temperature (e.g., ° C.) to which electrode 101 is heated to by hot rollers 280, 281, (iii) the time (e.g., milliseconds, seconds, or minutes) over which electrode 101 is maintained at the elevated temperature following heating by hot rollers 280, 281, and (iv) the rate (e.g., −° C./min) at which the temperature of electrode 101 is decreased from the elevated temperature back to the ambient room temperature by cold rollers 285, 286. In this embodiment where heating device 180 comprises the pair of hot rollers 280, 281 and cooling device 185 comprises the pair of cold rollers 285, 286, the heating rate of electrode 101 by heating device 180 (i.e., hot rollers 280, 281) preferably ranges from +40° C./min to +1.2×10⁴° C./min, alternatively ranges from +50° C./min to +4000° C./min, and alternatively ranges from +100° C./min to +600° C./min; the elevated temperature to which electrode 101 is heated from ambient room temperature the elevated temperature by heating device 180 (i.e., hot rollers 280, 281) is preferably greater than or equal to the melting point of the binder in electrode 101, and alternatively is about 200° C.; the time over which electrode 101 is maintained at the elevated temperature following heating by heating device 180 (i.e., hot rollers 280, 281) is preferably less than 10.0 s, alternatively less than 1.0 s, alternatively less than 0.10 s, alternatively less than 0.01 s, and alternatively less than 0.001 s; and the rate at which the temperature of dry powder is decreased from the elevated temperature back to the ambient room temperature by cooling device 185 (i.e., cold rollers 285, 286) is preferably faster than or equal to −100° C./min, alternatively faster than or equal to −200° C./min, and alternatively faster than or equal to −600° C./min, alternatively faster than or equal to −1.2×10⁴° C./min. As previously described, cooling rates are expressed as negative rates, and thus, a cooling rate of −600° C./min is a faster cooling rate (i.e., a faster temperature decrease) than a cooling rate of −200° C./min, which is a faster cooling rate (i.e., a faster temperature decrease) than-100° C./min. However, unlike system 100 previously described, in this embodiment of system 200, electrode processing sub-system 100b, and in particular hot rollers 280, 281 also mechanically processes electrode 101 via the application of compressional loads. Thus, electrode 101 is mechanically processed by heating electrode 101 simultaneously with applying compressional loads to electrode 101. The application of compressional loads to electrode 101 provides yet another parameter that can be used and adjusted to control the crystallinity and mechanical properties of electrode 102. Although electrode processing sub-system 100b and hot rollers 280, 281 heat electrode 101 simultaneously with the application of compressional loads to electrode 101, which may be referred to as “hot pressing,” in other embodiments, the electrode processing sub-system (e.g., system 100b) may apply compressional loads separate from (i.e., before or after) heating the electrode (e.g., electrode 101), which may be referred to as “cold pressing.”

Controlling one or more of the foregoing parameters during processing of electrode 101 with electrode processing sub-system 100b of system 200 offers the potential to advantageously decrease the crystallinity of the binder (e.g., thermoplastic binders) by about 1% to 40%, and alternatively by at least 20%. Thus, the crystallinity of the binder in processed electrode 102 may be about 1% to 40% less than the crystallinity of the binder in unprocessed electrode 101, and alternatively, the crystallinity of the binder in processed electrode 102 may be at least 20% less than the crystallinity of the binder in unprocessed electrode 101.

In the manner described, electrode production sub-system 100a of system 200 forms electrode 101 from dry powder 135 on substrate 105. Once formed, electrode 101 continues along feed direction 106 with substrate 105 to electrode processing sub-system 100b of system 200 where electrode 101 is further processed to enhance its mechanical properties.

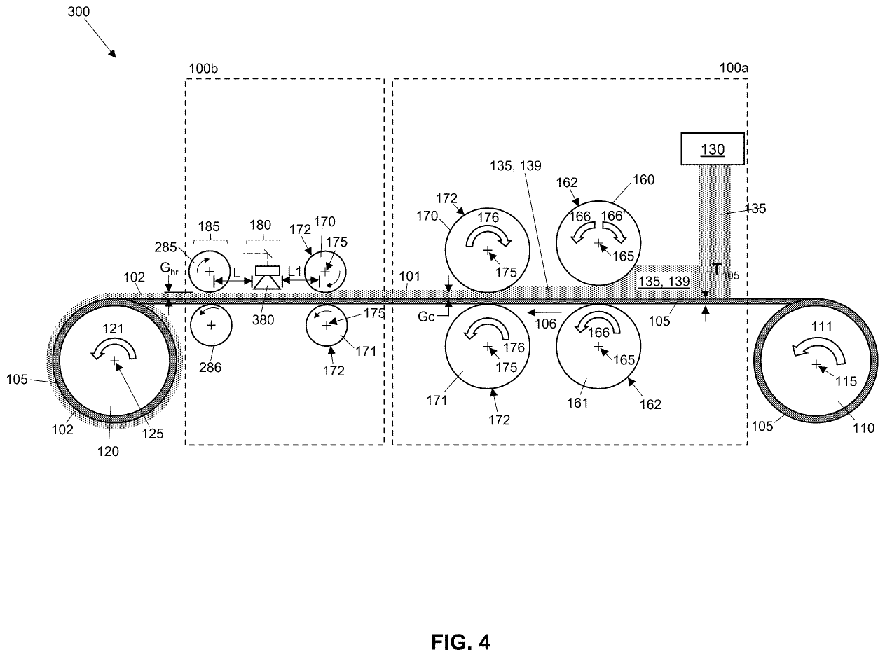

Referring now to FIG. 4, an embodiment of a system 300 for dry manufacturing electrodes for energy storage devices such as batteries (e.g., Li-ion batteries, solid-state batteries, etc.) is shown. System 300 is similar to system 100 previously described. In particular, system 300 includes an electrode production sub-system 100a that mechanically produces a continuous sheet or layer of electrode 101 on a web or substrate 105 from a solvent-free, dry powder 135; and an electrode processing sub-system 100b positioned downstream of sub-system 100a and that processes the produced layer of electrode material 101 to form a processed electrode material 102 with enhanced mechanical properties as compared to unprocessed electrode material 101. Electrode production sub-system 100a is as previously described. Electrode processing sub-system 100b is similar to electrode processing sub-system 100b previously described in that it includes a heating device 180 and a cooling device 185 spaced downstream of heating device 180 by a distance L measured as previously described. However, in this embodiment, heating device 180 is a laser heater 380 (e.g., a homogenized laser heater) and cooling device 185 comprises a pair of cold rollers 285, 286 as previously described. In addition, unlike systems 100, 200 previously described, in this embodiment, electrode processing sub-system 100b also includes a pair of compression rollers 170, 171 as previously described spaced upstream of heating device 180 by a distance L1. In embodiments disclosed herein, the distance L1 is defined as the minimum length of substrate 105 measured from the final or most downstream point at which compression is applied to electrode 101 within processing sub-system 100b (e.g., with compression rollers 170, 171) to the initial or most upstream point at which electrode 101 is heated with heating device 180. In this embodiment, the distance L1 is greater than or equal to 0.0 m and less than or equal to 2.0 m to control and adjust the pressure applied to electrode 101 just before or during heating electrode 101 with heating device 180.

Referring still to FIG. 4, compression rollers 170, 171 of electrode processing sub-system 100b are vertically-spaced apart a sufficient distance to provide a gap Gnr measured vertically from the upper surface of substrate 105 to the lowermost portion of outer surface 172 of upper compression roller 170. Thus, the vertical distance between compression rollers 170, 171 of electrode processing sub-system 100b is equal to the thickness T₁₀₅ plus gap Gₕᵣ. It should be appreciated that gap Gnr defines the vertical thickness to which electrode 101 is compacted on substrate 105 by compression rollers 170, 171 to process electrode 101 within electrode processing sub-system 100b. In embodiments described herein, gap Gₕᵣ, ranges from 0.0 to 3,000.0 micron, and alternatively ranges from 0.0 micron to 500.0 micron. In embodiments described herein, compression rollers 170, 171 of electrode processing sub-system 100b can apply a compaction load of up to about 3.5 tons/cm to compress electrode 101 (along a line contact between upper compression roller 170 and electrode 101), and more preferably apply a compaction load ranging from 0.0001 to 1.5 tons/cm to compress electrode 101 (along a line contact between upper compression roller 170 and electrode 101).

Referring still to FIG. 4, laser heater 380 applies and transfers thermal energy to electrode 101 to increase the temperature of electrode 101 at a heating rate (e.g., +° C./min) to an elevated temperature (e.g., ° C.), and maintain the temperature of electrode 101 at the elevated temperature for a predetermined period of time as will be described in more detail below. As previously described, cold rollers 285, 286 are chilled to a reduced temperature (relative to ambient room temperature) to remove thermal energy from electrode 101 to decrease the temperature of electrode 101 at a cooling rate (e.g., −° C./min) back to ambient room temperature as will be described in more detail below. In this embodiment, cold rollers 285, 286 of electrode processing sub-system 100b merely contact electrode 101 and substrate 105, respectively, to cool electrode 101 but do not apply compression to electrode 101 as cold rollers 285, 286 are vertically-spaced apart a distance equal to gap Gₕᵣ measured vertically from the upper surface of substrate 105 to the lowermost portion of outer surface 289 of upper cold roller 285. Thus, gap Gnr defines the thickness of processed electrode 102 exiting electrode processing sub-system 100b. However, in other embodiments, the cold rollers (e.g., cold rollers 285, 286) may be spaced to apply compression to the electrode (e.g., electrode 101).

As previously described, in embodiments described herein, it is generally preferred to at least partially melt and re-solidify the binder, and reduce the crystallinity of the binder in electrode 101 to enhance the mechanical properties of processed electrode 102 as compared to unprocessed electrode 101. In this embodiment, to achieve such reduction in the crystallinity of the binder in electrode 101, heating of electrode 101 by laser heater 380 and subsequent cooling of electrode 101 by cold rollers 285, 286 is performed in a similar manner as previously described by controlling one or more of (i) the rate (e.g., +° C./min) at which the temperature of electrode 101 is increased from the ambient room temperature by laser heater 380, (ii) the elevated temperature (e.g., ° C.) to which electrode 101 is heated to by laser heater 380, (iii) the time (e.g., milliseconds, seconds, or minutes) over which electrode 101 is maintained at the elevated temperature following heating by laser heater 380, and (iv) the rate (e.g., −° C./min) at which the temperature of electrode 101 is decreased from the elevated temperature back to the ambient room temperature by cold rollers 285, 286. In this embodiment where heating device 180 comprises laser heater 380 and cooling device 185 comprises the pair of cold rollers 285, 286, the heating rate of the electrode 101 by heating device 180 (i.e., laser heater 380) preferably ranges from +1.0×10⁴° C./min to 1.2×10⁷° C./min, alternatively ranges from +40° C./min to +1.2×10⁴° C./min, and alternatively ranges from +50° C./min to +4000° C./min; the elevated temperature to which electrode 101 is heated from ambient room temperature the elevated temperature by heating device 180 (i.e., laser heater 380) is preferably greater than or equal to the melting point of the binder in electrode 101, and alternatively is about 200° C.; the time over which electrode 101 is maintained at the elevated temperature following heating by heating device 180 (i.e., laser heater 380) is preferably less than 1.0 s, alternatively less than 0.10 s, alternatively less than 0.01 s, and alternatively less than 0.001 s; and the rate at which the temperature of dry powder is decreased from the elevated temperature back to the ambient room temperature by cooling device 185 (i.e., cold rollers 285, 286) is preferably faster than or equal to −100° C./min, alternatively faster than or equal to −200° C./min, alternatively faster than or equal to −600° C./min, alternatively faster than or equal to −1.2×10⁴° C./min, and alternatively faster than or equal to −1.2×10⁷° C./min. As previously described, cooling rates are expressed as negative rates, and thus, a cooling rate of −600° C./min is a faster cooling rate (i.e., a faster temperature decrease) than a cooling rate of −200° C./min, which is a faster cooling rate (i.e., a faster temperature decrease) than −100° C./min.

Unlike system 100 previously described, in this embodiment of system 300, electrode processing sub-system 100b, and in particular compression rollers 170, 171 mechanically processes electrode 101 via the application of compressional loads; and unlike system 200 previously described, compression rollers 170, 171 “cold press” electrode 101 prior to heating electrode 101. More specifically, electrode 101 is mechanically processed by compression rollers 170, 171 of electrode processing sub-system 100b, then subsequently heated by laser heater 380, and then cooled by cold rollers 185, 186. As previously described, the application of compressional loads to electrode 101 provides yet another parameter that can be used and adjusted to control the crystallinity and mechanical properties of electrode 102.

Controlling one or more of the foregoing parameters during processing of electrode 101 with electrode processing sub-system 100b of system 300 offers the potential to advantageously decrease the crystallinity of the binder (e.g., thermoplastic binders) by about 1% to 40%, and alternatively by at least 20%. Thus, the crystallinity of the binder in processed electrode 102 may be about 1% to 40% less than the crystallinity of the binder in unprocessed electrode 101, and alternatively, the crystallinity of the binder in processed electrode 102 may be at least 20% less than the crystallinity of the binder in unprocessed electrode 101.

In the manner described, electrode production sub-system 100a of system 300 forms electrode 101 from dry powder 135 on substrate 105. Once formed, electrode 101 continues along feed direction 106 with substrate 105 to electrode processing sub-system 100b of system 300 where electrode 101 is further processed to enhance its mechanical properties.

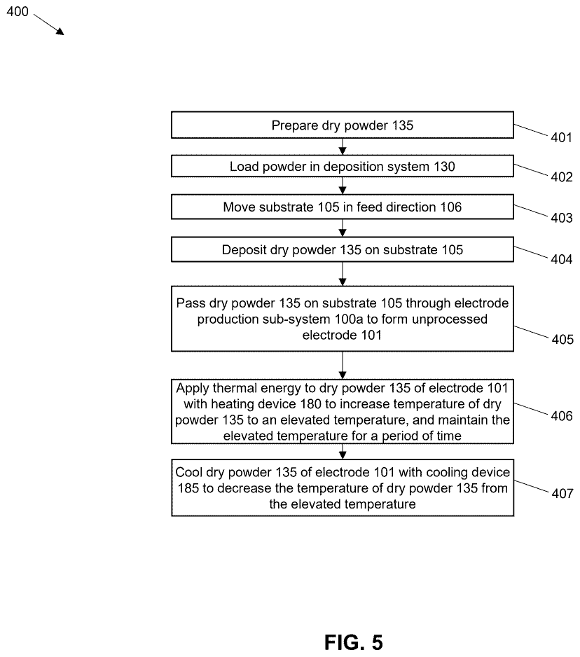

Referring now to FIG. 5, an embodiment of a method 400 for manufacturing processed electrode 102 on substrate 105 is shown. In general, method 400 can be performed with system 100, 200, 300 previously described and shown in FIGS. 1, 3, and 4, respectively, and thus, will be described with reference to systems 100, 200, 300.

In this embodiment, method 400 begins in block 401 in which dry powder 135 is prepared. As described above, in some embodiments, dry powder 135 comprises a plurality of nano-particle coated micro-particles (e.g., nano-particle coated micro-particles 193) and is “dry” (i.e., does not include any solvent and is not prepared using any solvent). Whereas, in other embodiments, dry powder 135 is made of a mixture of particles as previously described and is “dry,” but does not comprise a plurality of nano-particle coated micro-particles.

Next, in block 402, powder deposition system 130 is loaded with dry powder 135, and in block 403, substrate 105 is moved in feed direction 106 via rollers 110, 120. Moving now to block 404, dry powder 135 is deposited on substrate 105 as a generally continuous layer 139 by powder deposition system 130. Substrate 105 (moving in feed direction 106) transports dry powder 135 through the remainder of the system (e.g., system 100, 200, 300). In particular, substrate 105 transports dry powder 135 in feed direction 106 from powder deposition system 130 through electrode production sub-system 100a to form unprocessed electrode 101 in block 405, and then transports unprocessed electrode 101 to electrode processing sub-system 100b. Within electrode processing sub-system 100b, method 400 includes applying thermal energy to electrode 101 with heating device 180 in block 406 to increase the temperature of electrode 101 from room temperature at a pre-determined heating rate to a pre-determined elevated temperature as previously described. In addition, in block 406, the elevated temperature of electrode 101 is maintained for a pre-determined period of time as previously described. Optionally, compression can be applied to electrode 101 immediately before block 406 (e.g., with compression rollers 170, 171 of system 300 via “cold pressing”) or simultaneous with block 406 (e.g., with hot rollers 280, 281 of system 200 via “hot pressing”). Moving now to block 407, within electrode processing sub-system 100b, method 400 includes cooling electrode 101 with cooling device 185 to decrease the temperature of electrode 101 from the elevated temperature back down to room temperature at a pre-determined cooling rate as previously described. Through blocks 406, 407 of method 400, unprocessed electrode 101 is thermally and/or mechanically processed to form processed electrode 102. As previously described, such processing advantageously reduces the crystallinity of the binder within processed electrode 102 as compared to unprocessed electrode 101, thereby facilitating the improved mechanical properties of processed electrode 102 as compared to unprocessed electrode 101.

In the embodiments of systems 100, 200, 300 and method 400 previously described, electrode processing sub-system 100b is shown and described in connection with electrode production sub-system 100a, which relies on powder deposition system 130 and pairs of rollers 160, 161, 170, 170 to form electrode 101 on substrate 105 from dry powder 135. However, it should be appreciated that embodiments of electrode processing sub-system 100b can be used in connection with other types of electrode production systems, and thus, embodiments of electrode processing sub-system 100b are not limited to use with electrode sub-system 100a described herein.

### EXAMPLES

The subject matter having been generally described, the following examples are given as particular aspects of the disclosure and are included to demonstrate the practice and advantages thereof, as well as aspects and features of the presently disclosed subject matter. It should be appreciated by those of skill in the art that the techniques disclosed in the examples which follow represent techniques discovered by the inventors to function well in the practice of the present subject matter, and thus can be considered to constitute preferred modes for its practice. However, those of skill in the art should, in light of the present disclosure, appreciate that many changes can be made in the specific aspects which are disclosed and still obtain a like or similar result without departing from the scope of the instant disclosure. It is understood that the examples are given by way of illustration and are not intended to limit the specification of the claims to follow in any manner.

### Example 1

A variety of tests were conducted to assess the impact of thermal processing on the dry powder materials used in the solvent-free, dry manufacturing of electrodes. Compressed pellets of polyvinylidene fluoride (PVDF) powder (Kynar® HVS 900 Powder available from Arkema Inc. of Radnor, PA), which is a thermoplastic polymer often used as a binder in the solvent-free, dry manufacturing of electrodes, were formed and tested. In addition, compressed pellets of PVDF powder and carbon black (CB) powder (Super C65 Carbon Black available from MTI Corporation of Richmond, CA), which is often used as an additive in the solvent-free, dry manufacturing of electrodes, were formed and tested. Further, compressed pellets of polyvinylidene fluoride (PVDF) powder (Kynar® HVS 900 Powder available from Arkema Inc. of Radnor, PA), carbon black (CB) powder (Super C65 Carbon Black available from MTI Corporation of Richmond, CA), and lithium nickel-cobalt-manganese oxide (NMC) powder (available from MTI Corporation of Richmond, CA), which is often used as an active material in the solvent-free, dry manufacturing of electrodes, were formed and tested. For clarity, the pellets formed of exclusively of PVDF are referred to herein as “PVDF pellets,” the pellets formed of both PVDF and CB are referred to herein as “PVDF/CB composite pellets,” and the pellets formed of NMC/PVDF/CB are referred to herein as “NMC/PVDF/CB composite pellets.”

Each PVDF pellet was formed by loading 40 mg of the PVDF powder into a compress die with a 12.7 mm diameter, and then compressed (at room temperature) to a thickness of ~200 μm. The PVDF/CB composite pellets were formed by loading the PVDF powder and the CB powder into a mixing container in a 7:3 wt % ratio (70 wt % PVDF powder and 30 wt % CB powder), and then mixing the PVDF powder and the CB powder in a ball mixer at 3000 RPM for 6 minutes to ensure complete mixing of the PVDF powder and the CB powder (i.e., a substantially homogenous mixture). Next, 40 mg of the mixture of the PVDF powder and CB powder was loaded into the compress die, and then compressed (at room temperature) to a thickness of ~200 μm to form each PVDF/CB composite pellet. The NMC/PVDF/CB composite pellets were formed by loading the NMC powder, PVDF powder, and the CB powder into a mixing container in a 90:5:5 wt % ratio, respectively, and then mixing the NMC powder, the PVDF powder, and the CB powder in a ball mixer at 3000 RPM for 6 minutes to ensure complete mixing of the NMC powder, the PVDF powder, and the CB powder (i.e., a substantially homogenous mixture). Next, 40 mg of the mixture of the NMC powder, the PVDF powder, and CB powder was loaded into the compress die, and then compressed (at room temperature) to a thickness of ~200 μm to form each NMC/PVDF/CB composite pellet.

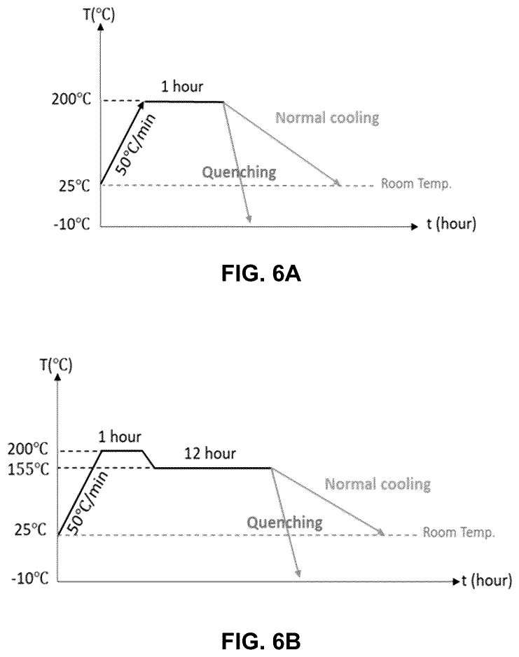

The PVDF pellets and the PVDF/CB composite pellets where subjected to thermal processing in accordance with the temperature profiles shown in FIGS. 6A and 6B. The temperature profile of FIG. 6A included (a) heat treating the sample (i.e., the PVDF pellet or the PVDF/CB composite pellet) by heating the sample at a rate of +50° C./min from room temperature to 200° C. with a hot plate and then holding the temperature of the sample at 200° C. for one hour; and then (b) cooling the sample by (i) quenching (i.e., rapidly cooling) the sample at a rate of −600° C./min with the assistance of a cold plate to a temperature of −10° C., or (ii) removing the sample from the hot plate and allowing the sample to cool without the assistance of the cold plate (or any cooling device) at a rate of about −10° C./min to room temperature. The temperature profile of FIG. 6B included (a) heat treating the sample (i.e., the PVDF pellet or the PVDF/CB composite pellet) by heating the sample at a rate of +50° C./min from room temperature to 200° C. with the hot plate, then holding the temperature of the sample at 200° C. for one hour, and then annealing the sample at a temperature of 155° C. for 12 hours; and then (b) cooling the sample by (i) quenching (i.e., rapidly cooling) the sample at a rate of −600° C./min with the assistance of the cold plate to a temperature of −10° C., or (ii) removing the sample from the hot plate and allowing the sample to cool without the assistance of the cold plate (or any cooling device) at a rate of about −10° C./min to room temperature. For clarity, samples cooled by quenching with the cold plate are designed with “Q,” samples allowed to normally cool without the assistance of the cold plate (or any other cooling device) are designated with “NC,” and samples subjected to the 12 hours of annealing at 155° C. are designated with “Anneal.”

Following thermal processing according to the temperature profiles shown in FIGS. 6A and 6B, a Differential Scanning calorimeter (DSC) (DSC Q20 available from TA Instruments of New Castle, Delaware, USA) was used to measure the heat of fusion and calculate the crystallinity of the thermally processed PVDF pellets and the thermally processed PVDF/CB composite pellets. In addition, DSC was used to measure the heat of fusion and calculate the crystallinity of unprocessed PVDF powder to use as a baseline or reference to compare the thermally processed PVDF pellets, and DSC was used to measure the heat of fusion and calculate the crystallinity of unprocessed PVDF/CB powder to use as a baseline or reference to compare the thermally processed PVDF/CB composite pellets.

Table 1 below shows the % crystallinity of the unprocessed PVDF powder, the % crystallinity of the thermally processed PVDF pellets, and the % change in crystallinity of the thermally processed PVDF pellets as compared to the baseline unprocessed PVDF powder. As shown in Table 1, thermal processing involving quenching of the PVDF pellets suppressed the crystallinity of the PVDF pellets with only+1% changes in the quenched PVDF pellets (PVDF_Q and PVDF_Anneal_Q) as compared to the unprocessed PVDF powder. On the other hand, PVDF pellets subjected to the normal cooling (PVDF_NC and PVDF_Anneal_NC) exhibited increased crystallinity (+17.45% and +22.59%) as compared to the unprocessed PVDF powder. Thus, rapid cooling via quenching with or without annealing resulted in minimal change in crystallinity while normal cooling with or without annealing appeared to result in high crystallinity.

TABLE 1

| PVDF | Crystallinity (%) | Crystallinity changed (%) |
|---|---|---|
| PVDF powder | 24.3 | — |
| PVDF_NC | 28.54 | +17.45 |
| PVDF_Q | 24.2 | −0.41 |
| PVDF_Anneal_NC | 29.79 | +22.59 |
| PVDF_Anneal_Q | 24.52 | +0.91 |

Table 2 below shows the melting temperature (Tₘ) of unprocessed (as-mixed) PVDF/CB powder, the melting temperature (Tₘ) of the thermally processed PVDF/CB composite pellets, the % crystallinity of unprocessed (as-mixed) PVDF/CB powder as a baseline or reference, the % crystallinity of the thermally processed PVDF/CB composite pellets, and the % change in crystallinity of the thermally processed PVDF/CB composite pellets as compared to the baseline unprocessed PVDF/CB powder. As shown in Table 2, the crystallinity of unprocessed PVDF/CB powder was 38.39%, which was greater than the 24.3% crystallinity of the unprocessed PVDF powder shown in Table 1 above. Without being limited by this or any particular theory, this is likely because partial or complete melting of PVDF occurs during dry mixing of the PVDF powder and CB powder, and further, because the CB nanoparticles could prompt the nucleation and crystallization resulting in higher crystallinity. As also shown in Table 2, thermal processing of the PVDF/CB composite pellets (according to both temperature profiles shown in FIGS. 6A and 6B) reduced crystallinity, with rapid cooling via quenching resulting in a greater reduction in crystallinity as compared to normal cooling, and annealing appearing to result in less reduction in crystallinity.

TABLE 2

| | Tₘ | Crystallinity | Crystallinity changed |
|---|---|---|---|
| PVDF/CB (7:3) | (° C.) | (%) | (%) |
| PVDF/CB powder | 164.3 | 38.39 | — |
| PVDF/CB_NC | 162.72 | 31.55 | −17.82 |
| PVDF/CB_Q | 160.73 | 30.2 | −21.33 |
| PVDF/CB_Anneal_NC | 162.43 | 32.75 | −14.69 |
| PVDF/CB_Anneal_Q | 161.6 | 31.51 | −17.92 |

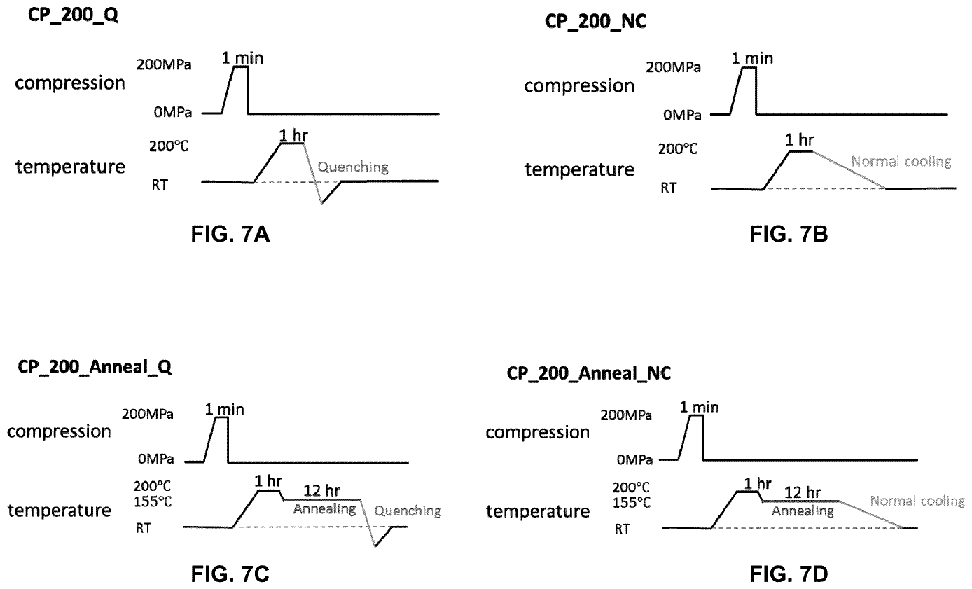

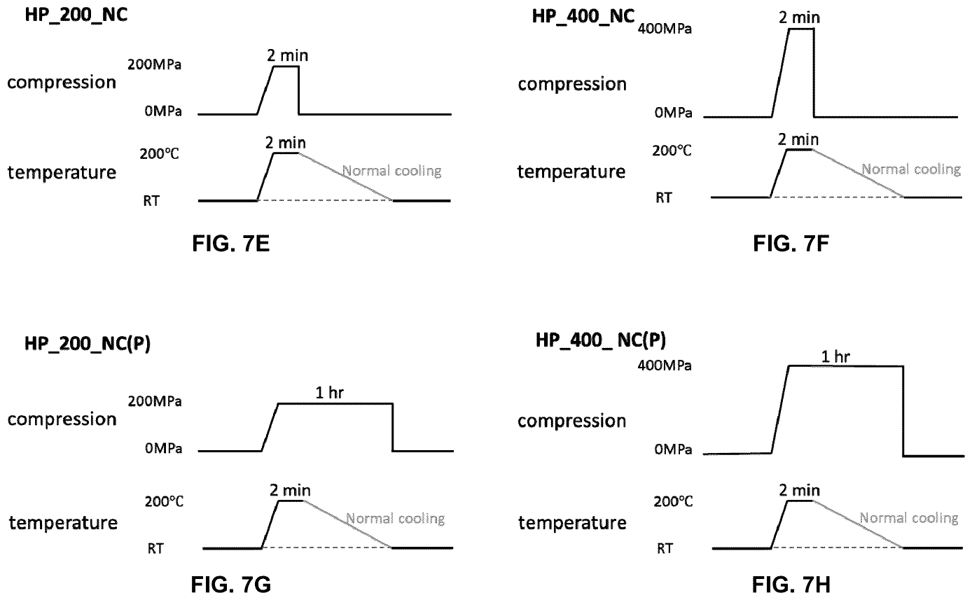

The NMC/PVDF/CB composite pellets where subjected to mechanical processing (cold pressing) and then thermal processing in accordance with the temperature profiles shown in FIGS. 7A and 7B. As previously described, the temperature profiles of FIGS. 7A and 7B included (a) cold pressing the sample (i.e., NMC/PVDF/CB composite pellet), (b) then heat treating the sample (i.e., NMC/PVDF/CB composite pellet) by heating the sample at a rate of +50° C./min from room temperature to 200° C. with a hot plate, (c) then holding the temperature of the sample at 200° C. for one hour; and then (d) cooling the sample by (i) quenching (i.e., rapidly cooling) the sample at a rate of −600° C./min with the assistance of a cold plate to a temperature of −10° C. (FIG. 7A), or (ii) removing the sample from the hot plate and allowing the sample to cool without the assistance of the cold plate (or any cooling device) at a rate of about −10° C./min to room temperature (FIG. 7B).

Following mechanical processing and thermal processing according to the temperature profiles shown in FIGS. 7A and 7B, the crystallinity of the thermally processed NMC/PVDF/CB composite pellets was investigated via DSC. The DSC results indicated the thermally processed NMC/PVDF/CB composite pellets cooled via quenching exhibited a lower crystallinity of 32.58% as compared to the 37.43% crystallinity of the thermally processed NMC/PVDF/CB composite pellet cooled via normal cooling.

### Example 2

PVDF pellets and PVDF/CB composite pellets made as previously described were also tested to assess the impact of thermal processing in combination with compression on the dry powder materials used in the solvent-free, dry manufacturing of electrodes. In the tests, the compression was applied before heating (referred to herein as “cold pressing” or “CP”) or concurrently with heating (referred to herein as “hot pressing” or “HP”).

For cold pressing, four post-compression heat treatments were used to investigate the effects of thermal processing on mechanical properties of the cold pressed sample (i.e., the PVDF pellet or the PVDF/CB composite pellet). The cold pressing prior to the heat treatments was perforned at a compression pressure of 200 MPa. In each of the post-compression heat treatments, the cold pressed sample (i.e., the PVDF pellet or the PVDF/CB composite pellet) was heated to 200° C. at a heating rate of +50° C./min (after compression), held at 200° C. for one hour or held at 200° C. for one hour followed by annealing at 155° C. for 12 hours as previously described, and then subjected to cooling via quenching or normal cooling as previously described. The cold press samples (i.e., the PVDF pellets and the PVDF/CB composite pellets) heat treated at 200° C. for 1 hour are labeled as CP_200_Q or CP_200_NC with “200” indicating the cold press compression pressure of 200 MPa, “Q” indicating quenching after heat treatment (−600° C./min), and “NC” indicating normal cooling (about −10° C./min) to room temperature after heat treatment. The temperature and pressure profiles for these cold pressed samples are shown in FIGS. 7A and 7B. The cold press samples subjected to the additional annealing are labeled as CP_200_Anneal_Q or CP_200_Anneal_NC, with “Anneal” indicating the additional annealing treatment via a long temperature hold step at 155° C. for 12 hours before cooling. The temperature and pressure profiles for these cold pressed samples are shown in FIGS. 7C and 7D.

For hot pressing, four heat treatments were used to investigate the effects of thermal processing on mechanical properties of the hot pressed sample (i.e., the PVDF pellet or the PVDF/CB composite pellet). The hot pressing was performed at a compression pressure of 200 MPa or 400 MPa (i) concurrent with heating the sample to 200° C. at a heating rate of +50° C./min and maintaining the temperature of the sample at 200° C., or (ii) concurrent with heating the sample to 200° C. at a heating rate of +50° C./min, maintaining the temperature of the sample at 200° C., and cooling of the sample to room temperature. In all hot pressing tests, cooling was performed via normal cooling (about −10° C./min) as previously described. The hot pressed samples (i.e., the PVDF pellets and the PVDF/CB composite pellets) subjected to compression concurrent with heating the sample and maintenance of the sample at the temperature of 200° C. are labeled as HP_200_NC or HP_400_NC with “200” or “400” indicating the compression pressure in MPa and “NC” indicating normal cooling to room temperature. The temperature and pressure profiles for these hot pressed samples are shown in FIGS. 7E and 7F. The hot pressed samples (i.e., the PVDF pellets and the PVDF/CB composite pellets) subjected to compression concurrent with heating the sample, maintenance of the sample at the temperature at 200° C., and cooling are labeled as HP_200_NC (P) and HP_400_NC (P) with “200” or “400” indicating the compression pressure in MPa, “NC” indicating normal cooling to room temperature, and “(P)” indicating the extended duration of the compression during heating, maintenance of the temperature at 200° C., and subsequent cooling. The temperature and pressure profiles for these hot pressed samples are shown in FIGS. 7G and 7H.

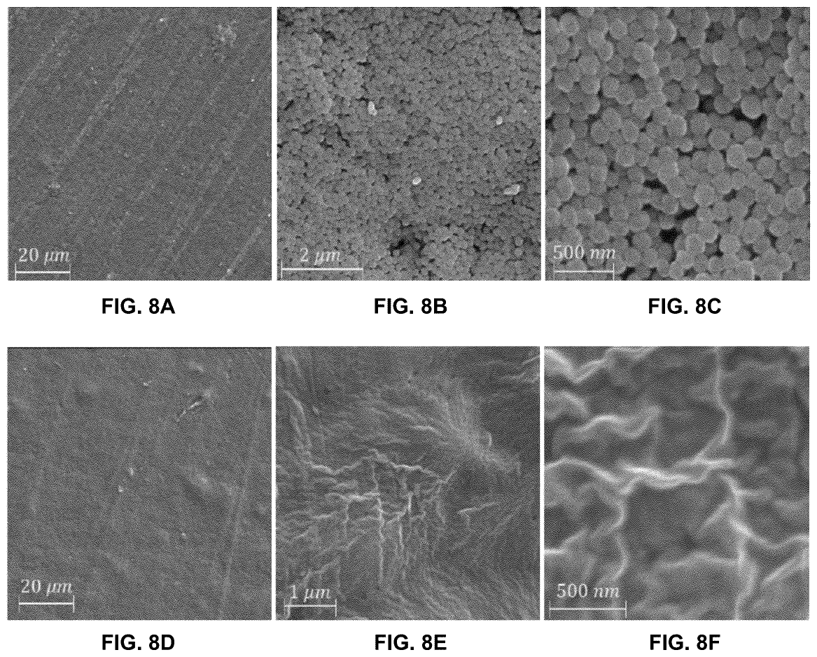

FIGS. 8A, 8B, and 8C illustrate scanning electron microscope (SEM) images of the microstructure of a cold pressed PVDF pellet subjected to a 200 MPa compression pressure without any heat treatment at resolutions of 20 μm, 2 μm, and 500 nm, respectively; and FIGS. 8D, 8E, and 8F illustrate SEM images of the microstructure of a cold pressed PVDF pellet subjected to a 200 MPa compression pressure followed by a heat treatment at 200° C. for 1 hour, and then allowed to cool via normal cooling (about-10° C./min) at resolutions of 20 μm, 1 μm, and 500 nm, respectively. Without heat treatment, the cold-pressed PVDF pellet generally remained porous due to insufficient molecular mobility, and many pores were visible in the high-resolution SEM images. In contrast, the cold-pressed PVDF pellet subjected to the heat treatment exhibited a more integrated structure without pores.

The crystallinities of (a) the cold pressed and hot pressed PVDF pellets following the heat treatments and (b) the cold pressed and the hot pressed PVDF/CB composite pellets following the heat treatments were characterized by DSC and summarized in Tables 3 and 4 below, respectively. In addition, the crystallinity of unprocessed PVDF powder (not thermally processed or compressed) was characterized by DSC, is shown in Table 3, and was used as a baseline or reference to compare the cold pressed and hot pressed PVDF pellets following the heat treatments; and the crystallinity of unprocessed PVDF/CB powder (not thermally processed or compressed) was characterized by DSC, is shown in Table 4, and was used as a baseline or reference to compare the cold pressed and hot pressed PVDF/CB composite pellets following the heat treatments. The change in crystallinity of the cold pressed and hot pressed PVDF pellets as compared to the unprocessed PVDF powder is also shown in Table 3, and the change in crystallinity of the cold pressed and hot pressed PVDF/CB composite pellets as compared to the unprocessed PVDF/CB powder is also shown in Table 4.

TABLE 3
Crystallinity and change in crystallinity of cold
and hot pressed PVDF pellets after heat treatment

| Pure PVDF | Crystallinity (%) | Crystallinity changed (%) |
|---|---|---|
| PVDF powder | 24.3 | — |
| CP_200_NC | 28.54 | +17.45 |
| CP_200_Q | 24.2 | −0.41 |
| CP_200_Anneal_NC | 29.79 | +22.59 |
| CP_200_Anneal_Q | 24.52 | +0.91 |
| HP_200_NC | 31.87 | +31.15 |
| HP_400_NC | 31.6 | +30.04 |
| HP_200_NC(P) | 27.71 | +14.03 |
| HP_400_NC(P) | 27.86 | +14.65 |

TABLE 4
Crystallinity and change in crystallinity of cold and hot
pressed PVDF/CB composite pellets after heat treatment

| PVDF/CB (7:3) | Crystallinity (%) | Crystallinity changed (%) |
|---|---|---|
| PVDF/CB powder | 38.39 | — |
| CP_200_NC | 31.55 | −17.82 |
| CP_200_Q | 30.2 | −21.33 |
| CP_200_Anneal_NC | 32.75 | −14.69 |
| CP_200_Anneal_Q | 31.51 | −17.92 |
| HP_200_NC | 31.44 | −18.10 |
| HP_400_NC | 31.65 | −17.56 |
| HP_200_NC(P) | 37.05 | −3.49 |
| HP_400_NC(P) | 36.78 | −4.19 |

Table 3 indicates the heat treatment and cooling via quenching (Q) in the PVDF pellets suppressed crystallinity, with only <+1% changes in the cold pressed PVDF pellets (CP_200_Q and CP_200_Anneal_Q) as compared to the unprocessed PVDF powder. On the other hand, cold pressed PVDF pellets subjected to heat treatment followed by normal cooling (NC) (CP_200_NC and CP_200_Anneal_NC) resulted in increased crystallinity (+17.45% and +22.59%) as compared to the unprocessed PVDF powder. For hot pressed PVDF pellets, crystallinity increased overall, ranging from +14.03% to +31.15% as compared to the unprocessed PVDF powder. Notably, hot pressed PVDF pellets cooled to room temperature under compression (HP_200_NC (P) and HP_400_NC (P)) showed relatively lower crystallinity as compared to hot pressed PVDF pellets cooled to room temperature without compression (HP_200_NC and HP_400_NC). It appears that, in the cases of HP_200_NC (P) and HP_400_NC (P), cooling under compression suppressed recrystallization of the PVDF pellet during cooling.

Table 4 indicates the heat treatment and cooling via quenching (Q) in the PVDF/CB composite pellets (CP_200_Q) reduced crystallinity by over 21% as compared to the unprocessed PVDF/CB powder. On the other hand, the hot-pressed PVDF/CB composite pellets (HP_200_NC and HP_400_NC) exhibited a crystallinity reduction of about-18% as compared to the unprocessed PVDF/CB powder. Similar crystallinity reductions were observed in the CP_200_NC and CP_200_Anneal_Q samples, with reductions of −17.82% and −17.92%, respectively, as compared to the unprocessed PVDF/CB powder.

To summarize, in the case of the PVDF pellets, cooling via quenching limited the crystallinity change within <+1%, whereas in the case of the PVDF/CB composite pellets, cooling via quenching reduced the crystallinity by more than 21%. These findings suggest and/or confirm that thermal processing can effectively adjust crystallinity, which can be used to tailor and enhance mechanical properties of solvent-free, dry manufactured electrodes.

### Example 3

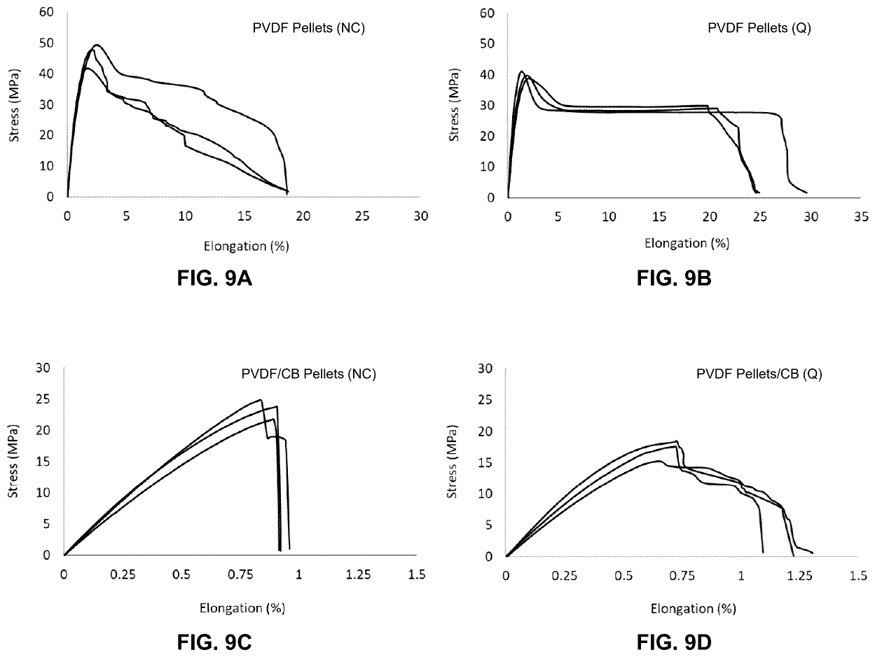

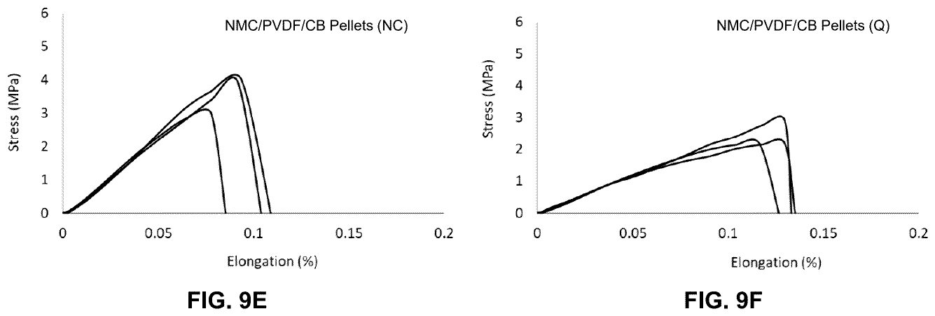

Uniaxial tensile tests were performed using an Instron tester (5984) at a rate of 2 mm/min on the PVDF pellets subjected to mechanical processing (cold pressing) and then thermal processing in accordance with the temperature profiles shown in FIGS. 7A and 7B, the PVDF/CB composite pellets subjected to mechanical processing (cold pressing) and then thermal processing in accordance with the temperature profiles shown in FIGS. 7A and 7B, and the NMC/PVDF/CB composite pellets subjected to mechanical processing (cold pressing) and then thermal processing in accordance with the temperature profiles shown in FIGS. 7A and 7B. The results of such tensile tests are shown in the stress-strain curves of FIGS. 9A to 9F, wherein FIGS. 9A and 9B illustrate the stress-strain curve for PVDF pellets normally cooled (FIG. 7B) and quenched (FIG. 7A), respectively; FIGS. 9C and 9D illustrate the stress-strain curve for the PVDF/CB composite pellets normally cooled (FIG. 7B) and quenched (FIG. 7A), respectively; and FIGS. 9E and 9F illustrate the stress-strain curve for the NMC/PVDF/CB composite pellets normally cooled (FIG. 7B) and quenched (FIG. 7A), respectively.

As shown in FIGS. 9A and 9B, the PVDF pellets mechanically processed and then thermally processed with normal cooling (FIG. 9A) exhibited less deformation after yielding and fractured earlier, whereas the PVDF pellets mechanically processed and then thermally processed with quenching (FIG. 9B) advantageously exhibited more ductile behavior, with continuous yielding and greater elongation before breaking. As shown in FIGS. 9C and 9D, the PVDF/CB composite pellets mechanically processed and then thermally processed with normal cooling (FIG. 9C) exhibited a relatively brittle response after yielding, whereas the PVDF/CB composite pellets mechanically processed and then thermally processed with quenching (FIG. 9D) advantageously exhibited greater elongation and ductility before failure, as indicated by the differences in the elastic slopes and deformation behavior. As shown in FIGS. 9E and 9F, the NMC/PVDF/CB composite pellets mechanically processed and then thermally processed with normal cooling (FIG. 9E) exhibited slightly higher tensile strength but reduced elongation, whereas the NMC/PVDF/CB composite pellets mechanically processed and then thermally processed with quenching (FIG. 9F) advantageously exhibited slightly higher elongation. Thus, the tensile test results revealed distinct failure behaviors between thermal processing with normal cooling versus quenching, thereby highlighting the impact of thermal processing on mechanical properties. It should also be appreciated that the tensile testing results generally align with the crystallinity analyses previously described. Namely, normal cooling resulted in higher crystallinity, which enhances ultimate strength but compromises elongation; whereas, quenching suppressed crystallization, leading to lower crystallinity. Table 5 below summarizes the tensile testing results for the thermally processed PVDF pellets, the thermally processed PVDF/CB pellets, and the thermally processed NMC/PVDF/CB pellets.

TABLE 5
Summary of Tensile Test Results

| | |
|---|---|
| Ultimate tensile | Elongation at |
| strength (MPa) | break (%) |

PVDF Pellets

| | | |
|---|---|---|
| PVDF (NC) | 46.08 ± 3.05 | 18.65 ± 0.08 |
| PVDF (Q) | 39.81 ± 1.12 | 26.20 ± 2.8 |

PVDF/CB Pellets

| | | |
|---|---|---|
| PVDF/CB (NC) | 24.18 ± 0.74 | 0.9 ± 0.02 |
| PVDF/CB (Q) | 17.98 ± 0.63 | 1.16 ± 0.09 |

NMC/PVDF/CB Pellets

| | | |
|---|---|---|
| NMC/PVDF/CB (NC) | 3.49 ± 0.74 | 0.10 ± 0.002 |
| NMC/PVDF/CB (Q) | 2.54 ± 0.52 | 0.13 ± 0.004 |

### Example 4

Additives previously described (including conductive additives), as well as the distributions of such additives, can also impact crystallinity and the mechanical properties of solvent-free, dry manufactured electrodes made in accordance with systems and methods described herein. Thus, the addition of additives and the mixing level of additives present another parameter that can be adjusted to tailor the crystallinity and mechanical properties of solvent-free, dry manufactured electrodes. Without being limited by theory, it is postulated that impacts and associated friction during mixing of the dry powder (e.g., dry powder 135) prior to deposition on the substrate (e.g., substrate 105) may melt the binder in the dry powder, which subsequently re-solidifies with reduced crystallinity. Table 6 below provides the crystallinity of five PVDF/CB composite dry powders comprising 70 wt % PVDF powder and 30 wt % CB powder prepared with various mixing levels as investigated via DSC. As shown in Table 5, the greater the mixing time, the greater the crystallinity.

TABLE 6
Crystallinity change of PVDF/CB composite
dry powder via various mixing levels

| PVDF/CB (7:3) powder | Tₘ (° C.) | Crystallinity (%) |
|---|---|---|
| No mix | 161.69 | 23.63 |
| Mix 10 sec | 161.64 | 23.66 |
| Mix 1 min | 161.89 | 26.05 |
| Mix 3 min | 161.86 | 36.46 |
| Mix 6 min | 164.3 | 38.39 |

In summary, through controlled application of pressure, thermal processing, mixing of additives, and combinations thereof, the crystallinity of the binder material in the dry powder (e.g., dry powder 135) forming a solvent-free, dry manufactured electrode (e.g., processed electrode 102) can be adjusted and precisely tuned, thereby offering the potential to enhance the mechanical properties of electrodes. Although PVDF was extensively tested and investigated in the Examples described above, embodiments described herein are not limited to PVDF binder, and further, embodiments of processing techniques disclosed herein (e.g., thermal processing, cold pressing, hot pressing, etc.) can be advantageously applied to other types of binders disclosed herein (e.g., other thermoplastic binders).

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A method for tailoring one or more mechanical properties of an electrode during the solvent-free, dry manufacture of the electrode, the method comprising:
(a) mixing a dry powder including a binder, wherein the binder in the dry powder has a first crystallinity;
(b) depositing the dry powder onto a substrate after (a);
(c) passing the dry powder through an electrode production sub-system to form an electrode from the dry powder on the substrate after (b);
(d) passing the electrode on the substrate through an electrode processing sub-system after (c);
(e) heating the electrode during (d) to a temperature greater than room temperature to at least partially melt the binder in the electrode; and
(f) cooling the electrode after (e) and during (d), wherein the binder in the electrode has a second crystallinity after (f) that is less than the first crystallinity.

2. The method of claim 1, wherein the binder has a melting temperature, and wherein (e) comprises increasing the temperature of the electrode to or above the melting temperature of the binder.

3. The method of claim 1, wherein (e) comprises increasing the temperature of the electrode to about 200° C.

4. The method of claim 1, wherein (e) comprises increasing the temperature of the electrode at a heating rate of at least +50° C./minute.

5. The method of claim 1, wherein (f) comprises cooling the dry powder at a cooling rate less than or equal to about −100° C./minute.

6. The method of claim 5, wherein the cooling rate is faster than or equal to −200° C./minute.

7. The method of claim 6, wherein the cooling rate is faster than or equal to −600° C./minute.

8. The method of claim 1, wherein the second crystallinity ranges from 1.0 to 40.0%.

9. The method of claim 7, wherein the second crystallinity is at least 20% less than the first crystallinity.

10. The method of claim 1, wherein the binder comprises a thermoplastic polymer.

11. The method of claim 10, wherein the thermoplastic polymer is polytetrafluoroethylene (PTFE), polyvinylidene fluoride (PVDF), poly(vinyl alcohol) (PVA), polyethylene oxide (PEO), poly(methyl methacrylate) (PMMA), styrene-butadiene rubber (SBR), polyurethane, ethylene vinyl acetate (EVA), an acrylic polymer, polyethylene (PE), or a combination thereof.

12. The method of claim 11, wherein the dry powder comprises a cathode material, an anode material, and an additive.

13. The method of claim 12, wherein the additive comprises carbon black (CB), carbon nanotube (CNT), nanoparticles, nanowires, nanotubes, nanosilica, nanoalumina, or a combination thereof.

14. The method of claim 1, further comprising compressing the electrode during (d) and before (e) or during (e).

15. A system for a solvent-free, dry manufacturing of an electrode, the system comprising:
a substrate configured to move in a feed direction;
a powder delivery system configured to deposit a dry powder onto a surface of the substrate, wherein the dry powder comprises a binder;
an electrode production sub-system configured to form an electrode on the substrate from the dry powder;
an electrode processing sub-system configured to thermally process the electrode, wherein the electrode processing sub-system comprises:
a heating device configured to increase a temperature of the electrode; and
a cooling device positioned downstream of the heating device relative to the feed direction, wherein the cooling device is configured to decrease the temperature of the electrode.

16. The system of claim 15, wherein the cooling device is configured to cool the electrode at a cooling rate less than or equal to about −100° C./minute.

17. The system of claim 15, wherein the binder has a melting temperature, and wherein the heating device is configured to increase the temperature of the dry power to the melting point the of binder or about 200° C.

18. The system of claim 15, wherein the cooling device is spaced a linear distance L from the heating device, wherein the distance L divided by a speed of the substrate in the feed direction is less than 1.0 seconds.

19. The system of claim 15, wherein the heating device comprises a conductive heating device, a radiative heating device, or an inductive heating device, and the cooling device comprises a chill roller, a cold substrate, or a cold gas stream.

20. The system of claim 15, wherein the dry powder comprises a cathode powder, an anode powder, and an additive.

21. The system of claim 20, wherein the additives comprise nanoparticles, nanowires, nanotubes, carbon black, nanosilica, nanoalumina, or a combination thereof.

22. The system of claim 20, wherein the binder comprises a thermoplastic polymer.

23. The system of claim 22, wherein the thermoplastic polymer is polytetrafluoroethylene (PTFE), polyvinylidene fluoride (PVDF), poly(vinyl alcohol) (PVA), polyethylene oxide (PEO), poly(methyl methacrylate) (PMMA), styrene-butadiene rubber (SBR), polyurethane, ethylene vinyl acetate (EVA), an acrylic polymer, polyethylene (PE), or a combination thereof.
